(19) United States
(12) Patent Application Publication
(10) Pub. No.: US 2017/0294060 A1
(43) Pub. Date: Oct. 12, 2017

(54) DEVICE FOR TEACHING A DRIVER TO DRIVE IN A FUEL EFFICIENT MANNER

(71) Applicant: Jonathan David Lanski, East Brunswick, NJ (US)

(72) Inventors: Jonathan David Lonski, East Brunswick, NJ (US); Hadi Karimi, Clemson, SC (US)

(73) Assignee: Jonathan David Lanski, East Brunswick, NJ (US)

(21) Appl. No.: 15/630,481

(22) Filed: Jun. 22, 2017

Related U.S. Application Data
(63) Continuation-in-part of application No. 14/798,989, filed on Jul. 14, 2015, now Pat. No. 9,718,476.

(51) Int. Cl. G07C 5/08; G01S 19/38; G07C 5/00; G01C 21/36; G06N 99/00; G06N 5/04

(52) U.S. Cl. CPC G07C 5/0841; G06N 99/005; G06N 5/04; G07C 5/008; G01C 21/3629; G01C 21/3641; G01C 21/3667; G01S 19/38

(57) ABSTRACT

A device is provided for teaching a driver of a vehicle in real-time to operate the vehicle in a fuel efficient manner based on feedback from a plurality on on-board sensors on the vehicle. The device calculates a score indicating how fuel efficient the driver is.

### CROSS-REFERENCE TO RELATED APPLICATIONS

This application is a Continuation-in-part of application Ser. No. 14/798,989 filed, Jul. 14, 2015, the entire disclosure of which is incorporated by reference.

### BACKGROUND

### 1. Field of the Disclosure

The present invention is directed to a device used to teach an operator of a vehicle a more fuel efficient way to operate the vehicle based on feedback from a plurality of devices installed on the vehicle.

### 2. Related Art

There are several mobile application based programs that use the on-board diagnostic system (OB-II port) on the vehicle to provide information to the driver.

U.S. Pat. No. 8,868,289 by Miljkovic, et al. and assigned to Automatic Labs, Inc. discloses a connector to the on-board diagnostic port of the vehicle in order to monitor the ignition state of the vehicle and to wirelessly transmit the ignition state, time, date and location information to a driver such as a driver's cell phone.

A few of the other mobile applications that are available are devices by Automatic, Mojio, and Zubie.

Automatic describes its device as a wireless adaptor that plugs into the car's diagnostic port and connects to the car owner's cell phone whenever the vehicle is driven. When enabled, the device will give audio warnings for speed. The device knows the vehicles location. Also, the device will export mileage data and issue a low fuel warning.

Mojio describes its device as a cellular GPS device that can connect with family and fiends, when the vehicle is driven, through personalized prompts, messages and geographical features. The device is described as a virtual driving assistant that analyzes and interprets data from the vehicle. The device provides a driving score which can be compared to other drivers that have the Mojio device. The device can send the vehicle's location to selected contacts. The device sends notifications to the cell phone of the vehicle's owner. The Mojio system is an open platform that allows developers to create new applications for the device.

Zubie describes its Zubie™ key as a device that connects to a vehicle to deliver safety features, vehicle diagnostics and driving insights to the vehicle owner's smartphone. The device monitors battery voltage. It can also alert the vehicle owner to engine problems. In addition, location information can be shared. The Zubie™ key plugs into the dashboard of the vehicle and connects wirelessly to the cloud. The device uses a built-in GPS.

The prior art devices all give driving tips and information after the trip is completed. None of the devices give real-time coaching to the driver while the driver is operating the vehicle.

### SUMMARY

The present invention is directed to teaching an operator of a vehicle in real-time improved fuel efficient driving habits to follow while driving based on feedback from the on-board diagnostic system of the vehicle, an angle of inclination of the vehicle, and an adaptive governor system on the vehicle.

One advantage of the present invention is that an operator of the vehicle is taught in real-time improved fuel efficient driving habits to follow. An instruction device instructs the driver of a vehicle. The instruction device includes a display screen displaying visual instructions, a speaker outputting audio instructions, sensors detecting an inclination angle of the vehicle relative to the x-axis, and a controller. The controller obtains vehicle diagnostics from an on-board diagnostic system of the vehicle, obtains GPS location information from a geo-mapping service, and obtains the inclination angle from the sensors. Using the GPS information, the controller also determines the elevation of the driver. The elevation information is also used to determine the inclination angle. For example, by determining a difference in elevation using GPS locations, the angle of inclination can be determined. The controller also determines a recommended speed and rate of acceleration for the driver to travel based on GPS information (e.g., location), posted speed limits, the elevation, and the inclination angle. Additionally, the controller takes into account the vehicle type (e.g., truck, sedan, etc.), make, model, and load weight for determining instructions for fuel-efficient driving. The controller determines instructions for fuel efficient driving and outputs the instructions via the display screen and speaker in real time while the driver is driving the vehicle.

An additional feature of the invention is that the controller calculates a score indicating how well the driver complies with the output instructions. The controller utilizes historic data of vehicle performance measures for calculating the score. According to an embodiment of the invention, the historic data includes performance measures recorded during the same route that the driver is traveling. The performance measures include, but are not limited to, total distance traveled, average miles per gallon (MPG), speed readings, revolution per minute (RPM) readings, over revolution percentage, top gear percentage, cruise control percentage, and idling percentage, as well as the GPS location, elevation, and inclination angle when these measures were recorded. The historic data is then used as a training set for a machine learning algorithm stored within a memory of the controller, which calculates the driver's performance of the current route, relative to the output instructions. The outputted performance can take the form of a grade on an A, B, C, D or F scale corresponding to values of 5, 4, 3, 2, and 1, respectively.

A further feature of the invention is that the controller obtains speed limits of roads the vehicle is travelling on. The controller outputs a maximum vehicle speed to an adaptive speed governor system of the vehicle.

Another feature of the invention is that the controller obtains speed limits of the road the vehicle is traveling on and outputs instructions in real-time via the display screen and speaker to the driver based on the obtained speed limits.

An additional feature of the invention is that the controller obtains maintenance information from the on-board diagnostic system, determines that the vehicle maintenance is affecting fuel efficiency and outputs the determination thereof to the driver.

A further feature of the invention is that the controller outputs the score indicating how well the driver complies with the output instructions to a web server.

Another feature of the invention is that the controller outputs the score indicating how well the driver complies with the output instructions to a cell phone of the driver.

An additional feature of the invention is that connectors connect the controller to the on-board diagnostic system.

A further feature of the invention is that the device further includes at least one light sensor to determine an amount of light entering an interior of the vehicle. The controller then updates the score based on the amount of light.

Another feature of the invention is providing a method of providing driving instructions to a driver of a vehicle. The method includes obtaining vehicle diagnostics from an on-board diagnostic system of the vehicle, obtaining GPS information from a geo-mapping service, obtaining an inclination angle of the vehicle and obtaining and outputting instructions for fuel efficient driving for a driver of the vehicle in real-time while the driver is driving the vehicle.

An additional feature of the invention includes outputting visual instructions for the driver of the vehicle.

Another feature of the invention includes outputting audio instructions for the driver of the vehicle.

A further feature of the invention is to calculate a score indicating how well the driver complied with the instructions.

Another feature of the invention is to obtain speed limits of the road the vehicle is traveling on and to output a maximum vehicle speed to an adaptive speed governor system of the vehicle.

An additional feature of the invention is to obtain speed limits of the road the vehicle is traveling on and to output visual instructions and audio instructions to the driver in real-time based on the obtained speed limits.

A further feature of the invention is to obtain maintenance information from the on-board diagnostic system and to determine if vehicle maintenance is affecting fuel efficiency.

An additional feature of the invention is to output the score to a web server.

A further feature of the invention is to output the score to a cell phone of the driver.

Another feature of the invention is to obtain an amount of light entering an interior of the vehicle from light sensors and updating the score based on the amount of light.

The foregoing and other features and advantages of the present invention will be more readily understood upon consideration of the following detailed description of the invention taken in conjunction with the accompanying drawings.

### BRIEF DESCRIPTION OF THE DRAWINGS

The present invention can be easily understood with reference to the following drawings which are for illustrative purposes only:

FIG. 1 discloses the device.

FIG. 2 illustrates the device connected to the dashboard of a vehicle.

FIG. 3 illustrates the internal systems of the device.

FIG. 4 illustrates a plot of performances measures according to an embodiment of the invention.

### DETAILED DESCRIPTION

The present invention will now be described with reference to the accompanying drawings in which a preferred embodiment is shown. The invention, however, may be embodied in many different forms and therefore should not be construed as limited to the embodiment as set forth herein.

The present invention is directed to a device to teach a driver of a vehicle driving techniques to improve vehicle fuel efficiency while the driver is driving the vehicle. The device uses feedback from the vehicle's on-board diagnostic system (e.g., OB-11 port J1962), an angle of inclination of the vehicle based on sensors inside the device itself or based upon GPS information, information inputted by the driver, such as make, model, and current load weight, and an adaptive governor provided on the vehicle. The adaptive governor system takes information from a geo-mapping service, such as a GPS system, in order to set a maximum speed the vehicle can achieve based on the road traveled. The geo-mapping service can be any well-known service that provides accurate GPS information. For example, known Qualcomm® units installed in certain vehicles may provide the necessary GPS information. However, the invention is not limited to Qualcomm® units, and other geo-mapping services are within the scope of the invention. The device calculates a score (e.g., A-F or 5-1) for the driver based on how well the driver complies with instructions from the device. A high score (e.g., A or 5) indicates good driving habits and fuel efficient driving. The driving score can be uploaded to a web server for evaluation by the driver, management personnel, a driving instructor or parent.

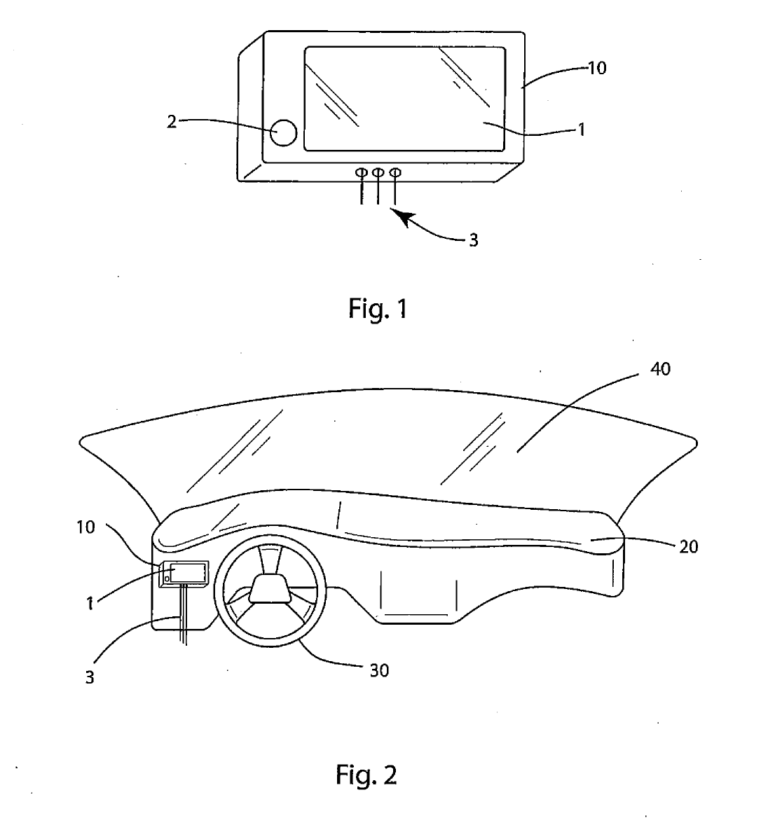

FIG. 1 shows the device 10 itself before it is installed in the vehicle. The device shown in FIG. 1 is for illustrative purposes only and should not limit the physical design itself. For example, the device may be circular or square rather than rectangular as illustrated. The device includes a display screen 1 and an audio system 2 which provides voice commands. The exact layout of the screen and audio system should not be limited to the illustration. The device also includes a place to attach connectors 3. The exact location of the connectors shown in the figure is also not limiting. The connectors 3 attach to the on-board diagnostic system of the vehicle, to the adaptive governor system, and to the geo-mapping service.

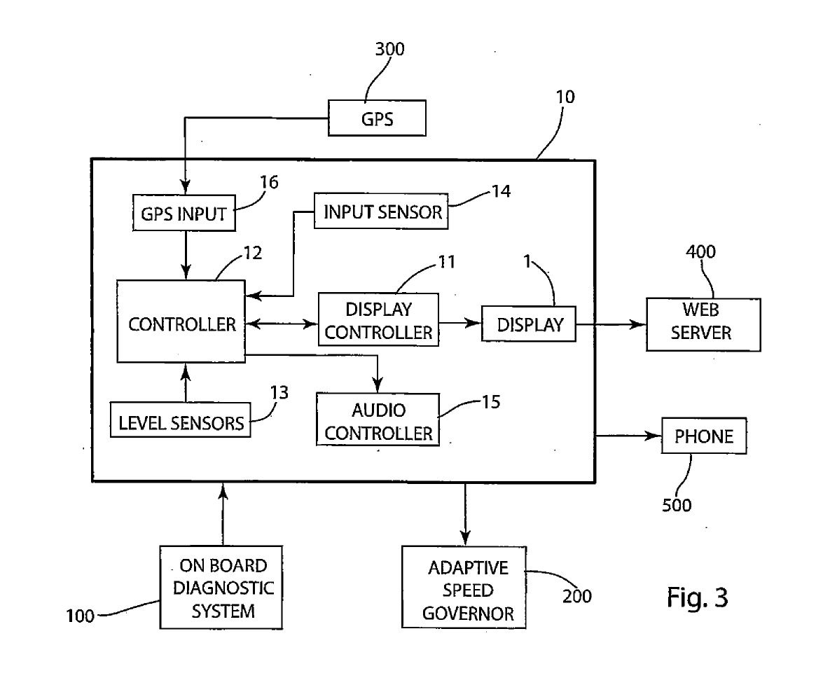

The device 10 has an input unit for the driver to enter information, such as vehicle type, make, model, and load weight of the vehicle. The input unit can be, for instance, a touch screen on the display screen 1. Other input devices and methods can also be used. Inside the device, as shown in FIG. 3, is at least a display controller 11 to control the display screen 1 and a controller or control unit 12 which obtains data from the on-board diagnostic system 100. The control unit 12 also obtains information from a geo-mapping service 300. The geo-mapping service can be a wireless service. The device 10 will receive signals from any GPS satellite and will retrieve data from a database to determine the speed limits at the location on the road where the vehicle is traveling.

In addition, the device 10 contains sensor(s) 13 to measure the angle of inclination of the vehicle. The sensor(s) 13 could be similar to a pendulum. As the vehicle moves up and down due to hills, the pendulum will move. The device will measure how far the pendulum has moved and calculate an angle of inclination of the vehicle. Although a pendulum is described here, the sensor(s) 13 are not limited thereto and can be any sensor(s) which measures an angle of inclination including accelerometers, gyroscopes, and the like. The output from the sensor(s) 13 is input to the control unit 12. In addition, or alternatively, the elevation information is used to determine the inclination angle. For example, using the geo-mapping service described above, the elevation is calculated while the vehicle is being operated. Elevation measurements can be recorded in real time or at discrete intervals (e.g., every second or minute). By determining a change in elevation between consecutive elevation measurements, the vehicle's angle of inclination is determined. The device 10 may also contain light sensor(s) 14. The output from the light sensor(s) 14 are input to the control unit 12 so that the amount of sunlight entering the vehicle can be determined.

FIG. 2 illustrates the device 10 mounted on a dashboard 20 of the vehicle adjacent to the steering wheel 30 and below the windshield 40 so the driver can see the display screen 1 of the device 10. Placement of device 10 in FIG. 2 is for illustration only and can be elsewhere in the vehicle. Connectors 3 connect the device 10 to the on-board diagnostic system 100, the adaptive speed governor 200, and to the geo-mapping service 300.

As the operator of the vehicle drives the vehicle, the control unit 12 of the device 10 will receive output signals from the on-board diagnostic system 100 for acceleration, total distance traveled, average miles per gallon (MPG), speed readings, revolution per minute (RPM) readings, over revolution percentage, top gear percentage, idle time, and time in cruise control. Additional output from the on-board diagnostic system 100 to the control unit 12 of the device 10 will be information about the maintenance of the vehicle. The information received by the control unit 12 will be used to determine if the maintenance is affecting the efficiency of the vehicle. In addition, the control unit 12 can determine if the vehicle needs to be serviced.

At the start of a trip, the display screen 1 will display information to the driver. In particular, the driver will be prompted to enter the weight of the load the vehicle is carrying or pulling. Additionally, the driver will be prompted to enter the vehicle type, make, and model. The driver can enter the information via the touch screen or via another type of input unit. Alternatively, the vehicle type, make, and model can be pre-loaded in the device. In addition, the control unit 12 will obtain output from the level sensor or inclination sensor 13, located within the device 10 itself, indicating the inclination of the vehicle and/or GPS information from the geo-mapping service. Based on at least one of the RPM, acceleration, idle time, cruise control information, over revolution percentage, top gear percentage, maintenance information, vehicle type, make, and model, weight of load, GPS information, and angle of inclination, the control unit 12 will output information to the display controller 11 for the display screen 1 to display visual instructions on how to increase fuel efficiency through better driving habits. In addition, audio instructions will also be provided to the driver via audio controller 15 to the audio system 2. The instructions include when to slow down, accelerate, maintain speed, accelerate more slowly, accelerate more quickly, etc.

According to an embodiment of the invention, these instructions are based at least in part upon determined speed and acceleration models. The speed model utilizes a current elevation of the vehicle, as determined from the GPS information or sensor(s) 13, in order to instruct the driver, at the lowest point on the route, to travel at the posted speed limit. At the highest point on the route, the device will instruct the driver travel at a specific speed, determined based upon the surplus time available to reach a destination, below the speed limit. Additionally, the acceleration model utilizes a calculated change in elevation in order to instruct the driver. For example, when a driver is going downhill and the elevation change is determined to be negative, the driver will be instructed to increase speed resulting in the acceleration model having a positive acceleration. When going uphill, the driver will be instructed to decrease speed and so the model will have a negative acceleration.

Thus, the device 10 will provide real-time coaching to the driver while the driver is operating the vehicle. The driving tips provided to the driver are based upon outputs from the on-board diagnostic system 100. Additionally, according to an embodiment of the invention, outputs from the inclination sensor(s) 13 which indicates the level of inclination of the vehicle as the vehicle is driving are also used. The device 10 also receives signals from the geo-mapping service 300 via the GPS input 16 about the speed limit of each road the vehicle is traveling on. The output from the geo-mapping service 300 to the device 10 will cause the control unit 12 to issue visual and audio alerts via the display screen 1 and audio system 2 to the driver such as when to slow down or accelerate ahead of time based on the route and the speed limit of the road.

Additionally, the vehicle may have an adaptive speed governor system 200. The adaptive speed governor system 200 is known in the art. The speed governor system 200 is a micro-controller based electronic unit which constantly monitors the speed of the vehicle and controls the vehicle speed within preset limits. Thus, the speed governor can restrict the maximum speed of a vehicle to a preset limit.

The device 10 of the present invention has the ability to control the computer system of the vehicle that regulates the governing speed of the vehicle by adjusting the maximum speed of the vehicle based on the speed limit of the road. The maximum speed of a vehicle is regulated by an on-board computer system. Rather than using a preset speed for the vehicle, the device 10 of the present invention would input the speed limit to the on-board computer system that the geo-mapping system provides for each road in order to set the maximum vehicle speed. Based on the maximum speed of the road from the geo-mapping service 300, the control unit 12 will output the maximum vehicle speed for the adaptive speed governing unit 200 in order to control the maximum speed the vehicle can go. This will aid the driver by preventing the vehicle from exceeding the speed limit for the road.

An additional feature of the device 10 is that the device will receive information about the maintenance of the vehicle from the on-board diagnostic port 100. The control unit 12 of the device 10 can then determine if maintenance of the vehicle is affecting the efficiency of the vehicle and whether the vehicle needs to be serviced. This is done by analyzing every possible alert the on-board diagnostic system outputs for maintenance issues and determining whether the alert affects fuel efficiency. For example, maintenance issues for vehicle lights do not affect fuel efficiency and can be ignored by the system according to an embodiment of the invention whereas tire pressure, and engine issues will affect fuel efficiency. In particular, the control unit 12 will classify if any maintenance issues are affecting fuel efficiency. In addition, the control unit 12 will determine how far the vehicle can still travel safely and/or efficiently before being serviced. This is based on the approximate number of miles the vehicle can still travel when the alert is issued before fuel efficiency is diminished at all, or before fuel efficiency is diminished below a certain threshold. This information can then be displayed to the driver or downloaded wired or wireless to a web server 400 or a smart phone 500.

Once the driver has finished traveling in the vehicle, the device 10 will use a system of formulas to calculate a score indicating how well the driver complied with the device's visual and audio instructions. The formula represents a pattern when the driver speeds up or slows down going up and down hills for an optimal vehicle route and mode of operation. The formula will change based on the weight the vehicle is carrying. The device will calculate the deviation between the vehicle's actual route and mode of operation and the optimal vehicle route and mode of operation.

According to an additional feature of the invention, the score is calculated using historic data of vehicle performance measures. The historic data is data recorded by other vehicles (or the same vehicle) traveling the same route as the driver. Performance measures include, but are not limited to, total distance traveled, average miles per gallon (MPG), speed readings, revolution per minute (RPM) readings, over revolution percentage, top gear percentage, cruise control percentage, and idling percentage, as well as the GPS location and elevation when these measures were recorded. Performance measures can be recorded at varying frequencies (e.g., continuously, every second, every minute, etc.). Accordingly to an embodiment, the performance measures are recorded every 2-5 minutes. The historic data is then used as a training set for a machine learning algorithm stored within the memory of the device 10. Utilizing the training set, the machine learning algorithm analyzes the historic data performance measures and how closely the historic data matched the speed and acceleration models to determine influences on fuel efficiency.

According to an embodiment of the invention, the historic data is organized into data sets based on each trip taken on the given route. For example, if ten drivers have each previously driven the route once, ten data sets of historic data are used. Alternatively, if one driver has previously driven the route five times, five data sets of historic data are used. Analysis begins with aggregating and sorting the historic data. This includes sorting the data sets based upon average MPG values. Data sets with a top mean MPG value are assigned to a first group, correspond to the top score (e.g., A or 5). According to an embodiment of the invention, this group corresponds to average MPG values in the top 12.5% of all data sets. Similarly, the next highest 20% of data sets are assigned to a second group, corresponding to a lower score (e.g., B or 4). The third group, corresponding to the next highest 35% of data sets, correspond to an even lower score (e.g., C or 3), while the next lowest 20% of data sets corresponding to the fourth group are assigned a score below that of the first to third groups (e.g., D or 2). Finally, data sets with the lowest 12.5% of average MPG values are assigned to the last group, corresponding to the lowest score (F or 1). The above groupings represent one embodiment of the invention, while other embodiments contemplate differing groupings using different percentages.

Once the historic data sets have been assigned to groups, the machine learning algorithm of the device analyzes the performance measures of each data set and determines correlations between the performance measures and the group that each data set is assigned to. In this way, the algorithm identifies the impact of performance measures on MPG, and thus fuel efficiency.

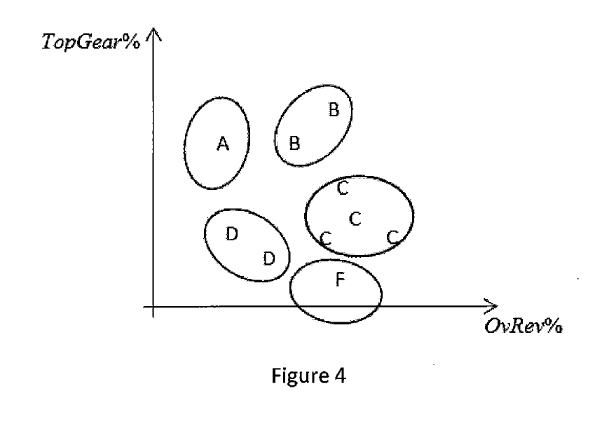

According to an embodiment of the invention, an average value for each performance measure from each data set are plotted against each other. Once the plot is complete, neighborhoods are defined within the plot based upon the group each average value on the plot corresponds to. FIG. 4 illustrates an example of such a plot, according to an embodiment of the invention. According to the embodiment of FIG. 4, the average value of top gear percentage is plotted against the average value of over revolution percentage for each data set. Each plotted point is then represented by its corresponding group (e.g., A-F). However, the invention is not limited to the above example, and any combination of two or more performance measures may be plotted and analyzed.

Additionally, different numbers of performance measures are also contemplated and within the scope of the invention. For example, the plot can take the form of a one-dimensional plot (e.g., x-axis only), when only one performance measure is analyzed, while the plot can also take the form of a three-dimensional plot (x, y, and z-axis) when three performance measures are analyzed. However, the invention contemplates a multi-dimensional plot of n axes, where n represents the number of performance measures being analyzed.

Neighborhoods within the plot are subsequently defined based upon the group that each average value of each data set belongs to. The definition of neighborhoods is carried out based on different distance criteria on the plot. Furthermore, the defined neighborhoods are subsequently optimized. According to an aspect of the invention, the neighborhoods are optimized using cross-validation and parameter tuning. The cross-validation assesses the strength of different classification approaches for a given training set, while parameter tuning optimizes the parameters in a classification algorithm. According to another aspect of the invention, the neighborhoods are iteratively updated and redefined as new data sets are recorded and added to the training set. By analyzing the performance measures of the plots and the group that each data set is assigned to the algorithm identifies the impact of performance measures on each other and on MPG.

Using the determined influences on fuel efficiency and the training set, as discussed above, the machine learning algorithm analyzes recorded performance measures of the driver in order to calculate a final score. According to an embodiment of the invention, the analysis includes plotting average values of performance measures of the driver on the plots previously generated using the training set discussed above. Each new plotted data point, having an unknown group (e.g., A-F), is analyzed by the machine learning algorithm utilizing the defined neighborhoods.

According to an aspect of the invention, this analysis includes creating predictive models from the historic data plots of the training set. Newly plotted data points are analyzed using a k-nearest neighbor method. According to this method, the machine learning algorithm chooses the k-nearest neighbors of the newly plotted data point (e.g., k=3) from the training set in determining what group to assign to the plotted point. Every point in a nearby group assigns a vote for the new data point and the group with the majority vote is elected as the one that new data point belongs to. This process is continuously carried out until all plotted data points are assigned a group.

According to a further aspect of the invention, in order to calculate the driver's compliance with the speed and acceleration models, the average values of the performance measures from the completed route are compared to model points from the predictive model and an R-squared value is calculated to identify what percentage of the variation in the dataset is explained by the model(s).

In order to calculate a final score, the R-squared values, along with the analysis of the average values of the performance measures, as discussed above, are used as inputs for the machine learning algorithm. Based upon the identified percentage of the variation in the dataset explained by the model(s) relating to the R-squared values and the determined influences of the average values of the performance measures on fuel efficiency, the final score for the given trip is calculated and provided to the driver. Additionally, a compound score is calculated for the driver based upon subsequent trips taken. The compound score is calculated based upon the distance the driver traveled, multiplied by the number value corresponding to the driver's score each time a route is completed. The sum of all of these values in a specified time period, divided by the total distance traveled in the same time period gives the driver an average compound score from 5-1 (or A-F) over that time period. In this way, the driver can be given a score indicating their fuel efficient driving habits over longer periods of time (e.g., a monthly or yearly score). However, the score, according to the invention, can be any score/grade that indicates an average performance grade for the driver over a period of time. For example, according to another embodiment of the invention the score/grade can take the form of values from 1-100 or 1-1000, depending upon the desired granulation.

Thus, the score will represent how fuel efficiently the driver was driving. The score will be sent to the web server 400 where the owner of the vehicle or manager of the vehicle can monitor and evaluate the driver's performance. The manager/owner will also be able to compare data prior to installation of the device 10 on the vehicle with data after installation of the device 10 on the vehicle in order to determine estimated cost savings from improved driving habits. This is especially important when the device 10 is installed on a commercial vehicle such as a truck.

According to another aspect of the invention, if there is no historic data available at the time the driver is using the device, the device will be placed in a training mode where it collects the performance measure data in order to develop the necessary data for the training set of the machine learning algorithm. However, according to an aspect of the invention, the device may still output instructions to the driver even when no historic data is available. If the route being driven has been preprogrammed (e.g., inputted by driver) the device can proactively calculate changes in elevation, and thus changes in inclination angle of the vehicle. Using this information and the speed and acceleration models, as discussed above, fuel efficient driving instructions are given to the driver.

A further feature of the device 10 is that light sensors 14 may be provided on the device 10 or the device 10 may be attached to light sensor(s) found within the interior of the vehicle. The output from the light sensor(s) are used by the control unit 12 to determine how much sunlight enters the vehicle. The determined amount of sunlight entering the vehicle is then used as a performance measure for the machine learning algorithm. The driver's score will improve when the driver allows sunlight to enter the vehicle while the vehicle is idle in the winter months since the increase in heat from the sunlight in the interior of the vehicle will allow the interior of the vehicle to warm up without turning the heater on. Similarly, the driver's score will improve in summer months when the idle vehicle is kept shaded in order to keep the interior of the vehicle cool without turning the air condition on to cool the vehicle.

According to an embodiment of the invention, these changes to the score are based upon a comparison of average sunlight values to the output of the light sensor(s) in conjunction with a threshold temperature. The average sunlight value is determined based upon historical data of how much sunlight entered other vehicles traveling the same route. Using this historical data, average values are calculated for each month of the year. The threshold temperature, according to an embodiment of the invention, is between 50 and 70 degrees Fahrenheit. According to another embodiment of the invention, the threshold is 60 degrees Fahrenheit. According to yet another embodiment of the invention, the threshold temperature value may be selected based upon publicly available weather service information.

For example, the score/grade is improved when the amount of sunlight detected is above the average sunlight value, for a specific month, when the temperature is below the threshold. Similarly, points are added when the amount of sunlight detected is below the average when the temperature is above the threshold. In addition, points are subtracted when the amount of sunlight detected is below the average when the temperature is below the threshold. Similarly, points are subtracted when the amount of sunlight detected is above the average when the temperature is above the threshold. The number of points added or subtracted is based upon how significant the algorithm determines the determined sunlight effects fuel efficiency. For example, according to an embodiment of the invention, the output from the light sensor(s) is used as a performance measure by the machine learning algorithm, as discussed above.

The present invention can be used in private vehicles as well as commercial vehicles. The present invention is directed to a device to coach a driver of the vehicle to have good driving habits. The present invention includes the angle of inclination of the vehicle into consideration when creating driving tips for the driver.

While the invention has been described above, it will be appreciated that modifications and changes may be made by those skilled in the art without departing from the spirit and scope of the invention. Thus, the scope of the invention should be defined by the appended claims.

What is claimed is:

1. An instruction device for instructing a driver of a vehicle comprising:
a display screen displaying visual instructions or a speaker outputting audio instructions; and
a controller, the controller configured to obtain:
vehicle diagnostics from an on-board diagnostic system of the vehicle; and
GPS information from a geo-mapping service;
wherein the controller determines instructions for fuel efficient driving and outputs the instructions via the display screen and/or speaker in real-time; and
wherein the controller calculates a score indicating how fuel efficiently the driver is driving based at least in part on the instructions and the vehicle diagnostics.

2. The instruction device according to claim 1, wherein the controller calculates the score indicating how fuel efficiently the driver is driving using a machine learning algorithm.

3. The instruction device according to claim 1,
wherein the vehicle diagnostics include at least one performance measure; and
wherein the at least one performance measure is selected from the group consisting of:
total distance traveled, average miles per gallon (MPG), speed readings, revolution per minute (RPM) readings, over revolution percentage, top gear percentage, cruise control percentage, and idling percentage.

4. The instruction device according to claim 3,
wherein the controller calculates the score based at least in part on a training set, the training set comprising historic data of the at least one performance measure.

5. The instruction device according to claim 4,
wherein the machine learning algorithm analyzes the training set and determines effects of the at least one performance measure on fuel efficiency based upon said analysis.

6. The instruction device according to claim 5, wherein the analysis comprises:
organizing the historic data of the training set into data sets, each data set corresponding to an individual route traveled;
assigning a group to each data set based at least in part on average miles per gallon values, each average miles per gallon value corresponding to the individual route traveled;
determining correlations between the at least one performance measure of the training set and fuel efficiency based upon the assigned groups.

7. The instruction device according to claim 6, wherein the analysis further comprises:
plotting an average value of the at least one performance measure of each data set of the training set;
defining regions within the plot based upon the assigned groups; and
creating predictive models based upon the plotted data sets.

8. The instruction device according to claim 7,
wherein the controller determines the score using the predictive models, the determined correlations and, statistical analysis of the vehicle diagnostics.

8. The instructions device according to claim 1, further comprising:
connectors connecting the controller to the on-board diagnostic system.

9. The instruction device according to claim 1, further comprising:
at least one light sensor to determine an amount of light entering an interior of the vehicle, wherein the controller updates the score based on the amount of light.

10. A method of providing driving instructions to a driver of a vehicle, comprising the steps of:
obtaining vehicle diagnostics from an on-board diagnostic system of the vehicle;
obtaining GPS information from a geo-mapping service;
determining and outputting instructions for fuel efficient driving for a driver of the vehicle in real-time while the driver is driving the vehicle; and
calculating a score indicating how fuel efficiently the driver is driving based at least in part on the instructions and the vehicle diagnostics.

11. The method according to claim 10,
wherein the vehicle diagnostics include at least one performance measure, and
wherein the at least one performance measure is selected from the group consisting of:
total distance traveled, average miles per gallon (MPG), speed readings, revolution per minute (RPM) readings, over revolution percentage, top gear percentage, cruise control percentage, and idling percentage.

12. The method according to claim 11, wherein the score is calculated based at least in part on a training set, the training set comprising historic data of the at least one performance measure.

13. The method according to claim 12, further comprising the steps of:
analyzing the training set; and
determining effects of the at least one performance measure on fuel efficiency based upon said analysis.

14. The method according to claim 13 wherein the analyzing step comprises:
organizing the historic data of the training set into data sets, each data set representing an individual route traveled;
assigning a group to each data set based at least in part on average miles per gallon values, each average miles per gallon value representing the individual route traveled;
determining correlations between the at least one performance measure of the training set and fuel efficiency based upon the assigned groups.

15. The method according to claim 10, wherein the analyzing step further comprises:
plotting the at least one performance measure of each data set of the training set;
defining regions within the plot based upon the assigned groups; and
creating predictive models based upon the plotted data sets.

16. The method according to claim 15, wherein the score is calculated using the predictive models, the determined correlations and, statistical analysis of the vehicle diagnostics.

17. The method according to claim 10, further comprising the step of outputting the score to a web server.

18. The method according to claim 10, further comprising the step of outputting the score to a cell phone of the driver.

19. The method according to claim 10, further comprising the step of:
obtaining an amount of light entering an interior of the vehicle from light sensors and updating the score based on the amount of light.
